(19) United States
(12) Patent Application Publication
(10) Pub. No.: US 2026/0269576 A1
(43) Pub. Date: Sep. 10, 2026

(54) TOUCH PROTECTION COVER ASSEMBLY WITH POSITION MARKS AND ELECTRICAL INSTALLATION DEVICE

(71) Applicant: Future Systems Besitz GmbH, Roedental (DE)

(72) Inventor: Bernhard FOERST, Kronach (DE)

(73) Assignee: Future Systems Besitz GmbH, Roedental (DE)

(21) Appl. No.: 19/657,796

(22) Filed: Apr. 24, 2026

Related U.S. Application Data
(63) Continuation of application No. PCT/EP2023/079677, filed on Oct. 24, 2023.

(51) Int. Cl. H02B 1/14; H02B 1/06; H02B 1/21

(52) U.S. Cl. CPC H02B 1/14; H02B 1/06; H02B 1/21

(57) ABSTRACT

A touch protection cover assembly is provided for covering at least one current busbar, and has a touch protection cover with a predetermined number of slits, the slits arranged at predetermined positions on the touch protection cover along a first direction. Each slit extends in a second direction perpendicular to the first direction, the slits allowing at least one electrical installation device to be mounted onto the busbar when the touch protection cover is attached to the current busbar. The assembly also includes a structure arranged along a first line on the touch protection cover, the line parallel to the first direction. The structure includes information descriptive for the touch protection cover, the information adapted to be sensed by the electrical installation device when mounted onto the current busbar.

### CROSS REFERENCE TO RELATED APPLICATIONS

This application is a continuation of International Application No. PCT/EP2023/079677, filed Oct. 24, 2023, the entire contents of which are incorporated by reference herein.

### FIELD OF THE INVENTION

The present invention relates to a touch protection cover assembly of a current busbar system as well as to an electrical installation device suitable for being attached to the current busbar system covered by the touch protection cover.

### BACKGROUND

Touch protection covers as parts of busbar systems are used in electrical installations to prevent humans from electric shock when e.g., handling the electrical installation devices for installation or de-installation or other services. Usually, the busbars along with their covers and the electrical installation devices attached to the busbars are enclosed in cabinets, the so-called switching cabinets.

The touch protection covers are usually mounted in front of the busbars such that they cover the busbars if not the complete interior surface of the switching cabinet. The electrical installation devices are attached and connected to the busbars through slits of the touch protection covers.

There is a need to know the exact actual positions of the electrical installation devices mounted onto the busbar system in the switching cabinet at any time, be it during assembling the switching cabinet or afterwards during operation lifetime and maintenance thereof.

In the art, this is accomplished visually by humans. This is not only cumbersome but also an error prone job.

Therefore, there is a need to provide means which alleviate this drawback.

### SUMMARY

This object may be addressed by devices as described herein.

Accordingly, provided is a touch protection cover assembly for covering at least one current busbar, comprising:
at least one touch protection cover with a predetermined number of slits, the slits being arranged at predetermined positions on the at least one touch protection cover along a first direction, each slit extending in a second direction which is perpendicular to the first direction,
the slits allowing at least one electrical installation device to be mounted onto the at least one busbar, when the at least one touch protection cover is attached to the at least one current busbar;

the touch protection cover assembly further comprising:
a structure being arranged along a first line on the at least one touch protection cover, which first line is parallel to the first direction,
the structure comprising information, which is descriptive for the at least one touch protection cover,
the information being adapted to be sensed by the at least one electrical installation device, when mounted onto the at least one current busbar.

Further provided is an electrical installation device suitable for being attached to at least one busbar at predetermined positions on at least one touch protection cover assembly as defined above, the touch protection cover assembly covering the at least one busbar, the electrical installation device further comprising:
means for sensing the information of the structure.

The electrical installation device or electrical component may be in particular one of the following: Engine control unit, power supply unit, adapter for electrical devices, measuring device, display device, converter unit, fuse holder, switch disconnector, switch disconnector with fuses, fuse switch disconnector, overvoltage touch protection device, lightning protection device, communication device, residual current circuit breaker, interference suppression device, controller.

### BRIEF DESCRIPTION OF THE DRAWING

The invention and embodiments thereof are described in more detail in connection with the drawing, in which:

FIG. 1a illustrates a touch protection cover assembly for covering three busbars,

FIG. 1b illustrates the busbars with the touch protection cover removed;

FIG. 2 illustrates bar patterns as first marks along with a scale of decimal figures;

FIG. 3 illustrates bar patterns representing a Gray code along with a scale of decimal figures;

FIG. 4 illustrates an implementation with the Gray code but without decimal figures;

FIG. 5 illustrates further implementations of graphical patterns;

FIG. 6a, b illustrate a touch protection cover 100 further comprising a second number of second marks m2;

FIG. 7a, b, c illustrate embodiments with a groove in the first direction;

FIG. 8a, b illustrate configurations with an additional communication busbar;

FIG. 9a, b illustrate an exemplary position sensing means.

### DETAILED DESCRIPTION

In the following, “up”, “down”, “horizontal, “vertical”, “in front of”, “behind” relate to orientations of one or more parts perceived by a human looking directly at those parts when they are mounted as intended.

For illustration purposes only, is assumed that busbars 20 of the busbar system run or extend in a first direction x, which is the horizontal direction here. Then, the second direction, perpendicular to the first direction, is the vertical direction, denoted here by y. The busbars are mounted, or intended to be mounted, at a vertical wall or surface enclosed by a switchboard cabinet.

It should be understood that the first, x, and second, y, directions may be reversed. That is, the busbars 20 may then run in the vertical direction.

Several busbars 20, as parts of the busbar system, run in parallel to each other. The busbars 20 may conduct high-voltage currents, e.g., 3 AC phases with more than 60 VDC, or 25 VAC, typically with about 400 VAC. These figures are only examples.

The electrical installation devices 200 may cover at least one busbar 20, usually all the busbars 20 of the busbar system and connect to them. The electrical installation devices may extend in the vertical direction y which ma also be denoted as the longitudinal direction of the electrical installation device.

The front or frontside of the electrical installation device, of the busbar system or of any part thereof is the side which is oriented to a human person standing in front of the electrical installation device, the busbar system or the part if they are mounted as intended.

The rear side is a side of a part which is oriented or faced to the background or away from a human standing in front of that part.

Additionally, at least one communication busbar 20D may be present which runs in the same direction as the other busbars. The communication busbar may transfer communication signals between the electrical installation devices and other units.

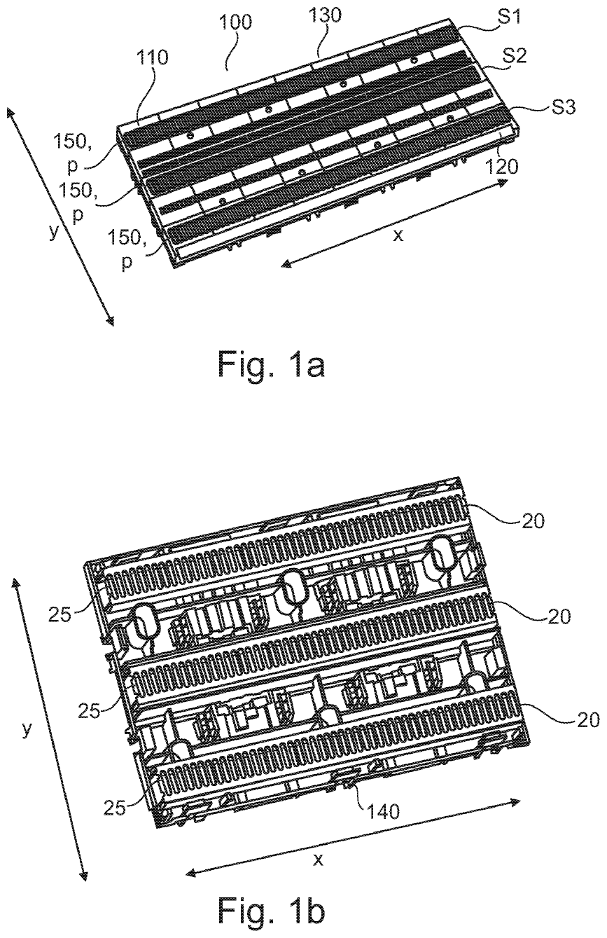

FIG. 1a illustrates a touch protection cover 100, as part of a touch protection cover assembly, for covering at least one current busbar of a busbar system in this example, three busbars 20, as will be described in connection with FIG. 1b. The busbars 20 run in the predetermined first direction x. The touch protection cover assembly may comprise several touch protection covers 100, depending on the size of the switching cabinet which encloses the busbars, the touch protection cover assembly and electrical installation devices 200 attached thereto.

Each touch protection cover 100 comprises at least one line S1, S2, S3 of slits 150 at predetermined positions p. The number of lines S1, S2, S3 corresponds to the number of busbars 20 of the busbar system to be covered by the touch protection cover 100. Each of the lines S1, S2, S3 of slits 150 is arranged in the first direction x, that is, in parallel to the busbars 20. The slits 150 are preferably equidistant to each other. The slits 150 are in front of the busbars 20, each line S1, S2, S3 of slits being in front of another one of the busbars 20 and allowing the electrical installation devices 200 to reach through with their attaching and connecting means to the at least one busbar 20. Each slit 150 extends in a second direction y which is perpendicular to the first direction x. The slits 150 define the possible positions p of electrical installation devices 200 along the first direction x on the touch protection cover 100.

FIG. 1b illustrates the busbar system with the touch protection cover 100 removed. As can be seen, there are three busbars 20. The busbars 20 are embedded into a back cover 140 of the touch protection assembly. The busbars 20, in this example, are U-profiled bars. The busbars 20 also may have slits 25 to receive the connecting and/or attaching means of the electrical installation devices 200. Those slits 25 are also arranged in the first direction x, are preferably equidistant to each other, and do also extend in the second direction y which is perpendicular to the first direction x. The slits 25, if present, should be aligned with the slits 150 of the touch protection cover 100. It is to be noted that the busbars 20 may have other profile forms, e.g., rectangular bars, with or without slits 25.

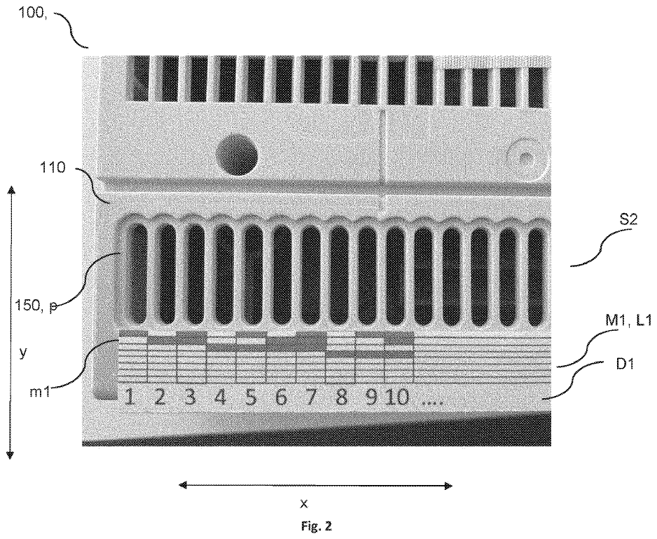

As illustrated in FIG. 2, the touch protection cover 100 further comprises a structure M1 being arranged along a first line L1 which is parallel to the first direction x and to the slit lines S1, S2, S3, the structure M1 comprising information m1, m2 which is descriptive for the touch protection cover 100.

The information m1 is descriptive insofar as it is representative of the predetermined positions p of the slits 150 on the cover 100 or of the slits 25 of the busbars 20. This information is implemented as a first set of first marks m1. The first marks m1 are arranged on the first straight line L1 in the first direction x and equidistantly to each other.

Each first mark m1 comprises information which makes it distinguishable from all other first marks m1 on the touch protection cover 100. Each slit 150 corresponds to a first mark m1. This may be the one mark m1 which has the same position in the first direction x as the slit 150. The first mark m1 and the slit 150 are on a straight line in the second direction y perpendicular to the first direction x.

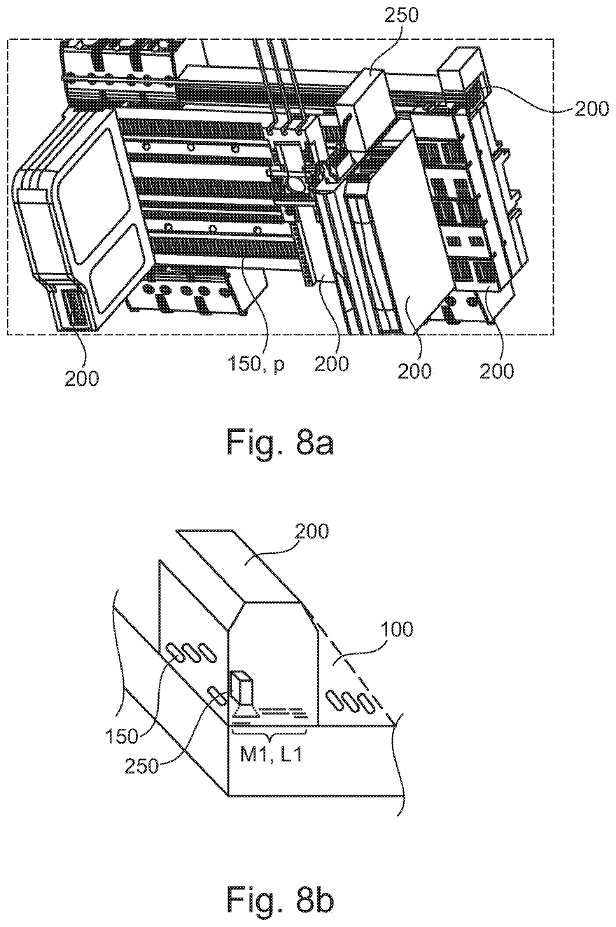

The information in the first marks m1 is machine-readable, e.g., by optical sensor means 250 like a CCD sensor device, by mechanical, magnetic or inductive means. If an electrical installation device 200 is equipped with suitable sensor means 250 it can determine its position p on the cover 100 in the switching cabinet by detecting the related first mark m1 when it is attached on the busbar system at the position p, refer to FIG. 8b.

The information in the first marks m1 may be embodied or coded in various forms. In some variants, the information is comprised in a graphical pattern. FIG. 2 to FIG. 6b illustrate bars as graphical pattern. Herein, several binary bars b1, . . . , b8 (e.g., black or white bars) are vertically aligned in the second direction y) under each slit 150. The coding may be according to a simple binary system. For coding 256 different positions along the direction x, corresponding to 256 slits 150 along the direction x, 8 bars (digits) are needed. To make the position easier human-readable, each first pattern may be associated with a decimal FIGS. 1, 2, 3 . . . , on a further line D1.

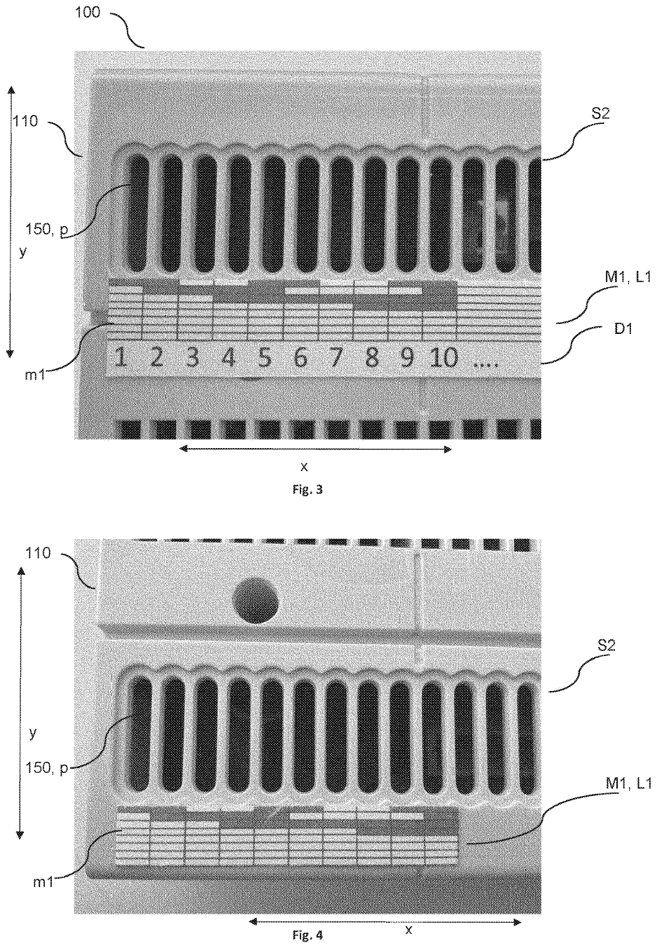

For coding the marks in binary codes, a Gray code may be used, that is each pair of adjacent marks along the first direction x differ from each other in exactly one of their digits, see FIG. 3.

FIG. 4 illustrates the implementation with the Gray code but without decimal figures, for saving space in the second, vertical, direction y.

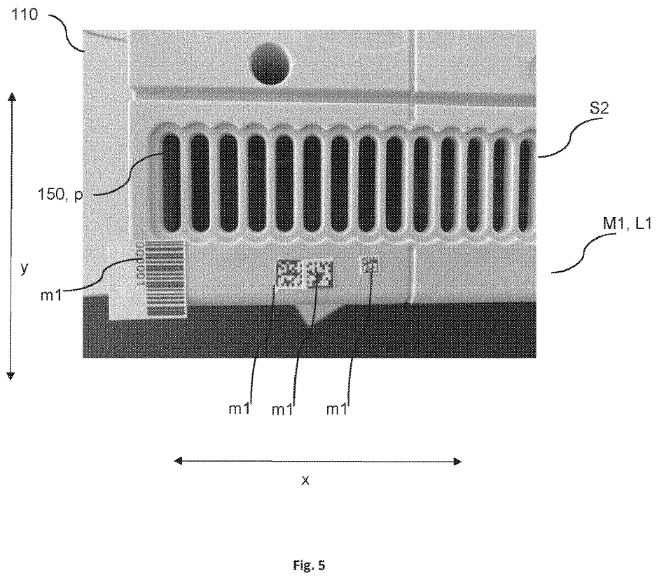

Further, the information may be coded in one-dimensional barcodes, e.g., 128 or in two-dimensional codes, e.g., Datamatrix 4×4 mm or 6×6 mm, or two-dimensional QR code, as collectively shown in FIG. 5.

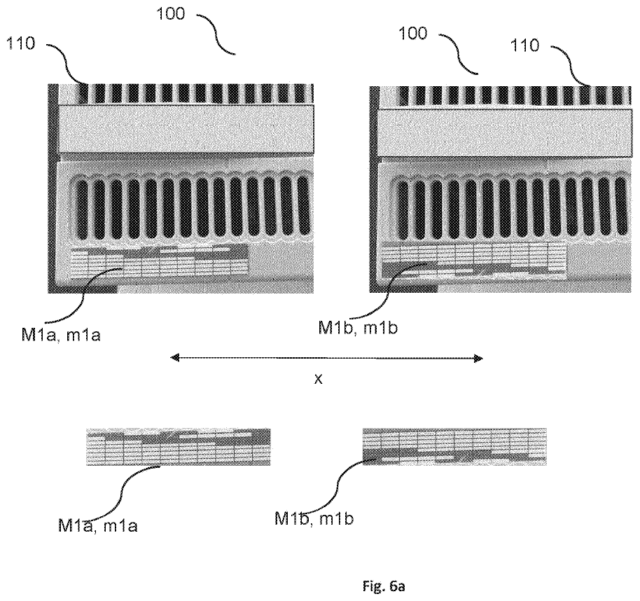

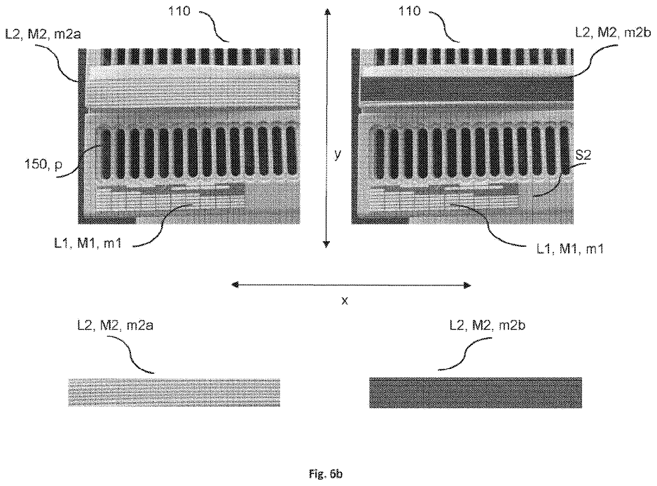

FIG. 6a, b relate to further embodiments of the invention. These embodiments relate to a touch protection cover assembly where several touch protection covers 100 are to be combined in one switching cabinet. Then, the several touch protection covers 100 should not have the identical position information. In order to make the position information unique over the several covers 100, either the respective first information or first sets of first marks m1 are not identical for all the touch protection covers 100, or individual second marks m2 are provided on each individual touch protection cover 100 additionally to the first marks m1. The individual second marks m2, m2a, m2b identify the individual cover 100, while the first set of first marks m1 is the same for all the covers 100.

FIG. 6a illustrates the case where non-identical first marks m1 are provided. In this case, the marks m1a, m1b, . . . may be comprised on structures M1a, M1b, . . . , respectively, initially physically separate from the covers 100. Such structures M1a, M1b, . . . may be on separate layers such as elongate strips made of plastic. The strips can be applied on the individual covers 100.

Different layers or strips with different structures M1a, M1b, . . . may be provided for the different first marks m1a, m1b. As an example., one strip with first structure M1a may comprise marks m1a running from 1 to 244, another strip with first structure M1b, may comprise first marks m1b running from 245 to 489, and so on.

The strips may be provided and shipped along with the covers 100, and the user may customize the covers 100 with the correct strip when assembling them to a touch protection cover assembly for the particular busbar system.

FIG. 6b illustrates the case where individual second set of second marks m2 is provided on each touch protection cover 100. The second marks m2 are representative of an individual information relating to an individual touch protection cover 100. That is, the individual information may comprise a position of that cover 100 with respect to the least one current busbar 2 in the switching cabinet, when mounted to the at least one busbar. The second marks m2 are arranged on a second straight line L2 in the first direction x. Each second mark m2a, m2b is preferably adjacent to one of the first marks m1. With the second set of second marks m2, m2a, m2b, several touch protection covers 100 can be made distinguishable from each other. Then, in assemblies where several touch protection covers 100 are present, each position in the first direction x on a touch protection cover 100 can be uniquely coded by the combination of a first mark m1 for the relative position on a particular cover 100 and a second mark m2 for the particular touch protection cover 100 out of the several touch protection covers 100. The second mark m2 may comprise the position of the individual protection cover 100 in the switching cabinet.

The first and second marks m1, m2 can be arranged on the front surface 110 of the touch protection cover 100. But if space on the front surface 110 of the touch protection cover 100 is an issue, the first and/or the second marks m1, m2 may be arranged on a lower side surface 120 of the touch protection cover, or on an upper side surface 130 surface of the touch protection cover 100. Of course they have to be placed on positions where they can be read by the sensor devices of the electrical installation devices in the switching cabinet.

The patterns or marks m1, m2 may be integrally formed with the touch protection cover 100. However, as described above, the first and/or the second patterns may be comprised in or on a separate layer or strips which can be applied on the respective touch protection cover. Such layers or strips may be made from plastics or any other suitable durable material. The touch protection cover may be customized with different code systems.

Hereby, the first set of first marks m1 may already be pre-fabricated on the touch protection covers since they may be all the same for each cover 100 while the second set of second marks m2 may be applied only upon actual installation of the particular touch protection covers on site, to make the covers 100 distinguishable from each other.

If it is sufficient to just know on which cover 100 out of a number of covers 100 making up the touch protection cover assembly an electrical installation device 200 is sitting, only second marks m2 identifying the individual cover may be provided on the touch protection cover 100. This may be an interesting option if the electrical installation devices 200 are quite large, such that e.g., only one of them is sitting on each touch protection cover 100.

In further variants, other physical types of the marks m1 and/or m2 and information may be employed. In particular, mechanically structured marks m1, m2 and codes may be used.

Such marks m1, m2 may comprise at least one elevation on a surface of the cover, and the information may be at least one height of the at least one elevation. In the way like embossed printing, the positions may be coded.

On the other hand, the marks m1, m2 may be in the form of recesses or blind holes in a surface of the touch protection covers, and the positions p are coded as the depths of the respective recesses or the holes.

Yet further variants are holes in a surface 110, 120, 130 of the cover 100, while the position information p is coded as the number of the holes in the surface of the protection cover at each position p, and/or is coded as the depth of the holes.

Furthermore, instead of first and/or second marks m1, m2 which vary in discrete steps depending on the first direction x, the information may be a in mark m3, located e.g., in the surface 110, which mark m3 varies continuously depending on the first direction x. Such a mark m3 may be a triangular surface pattern extending in the first direction x, and varying its height in the second direction y perpendicular to the first direction x, depending on the position p in the first direction x,

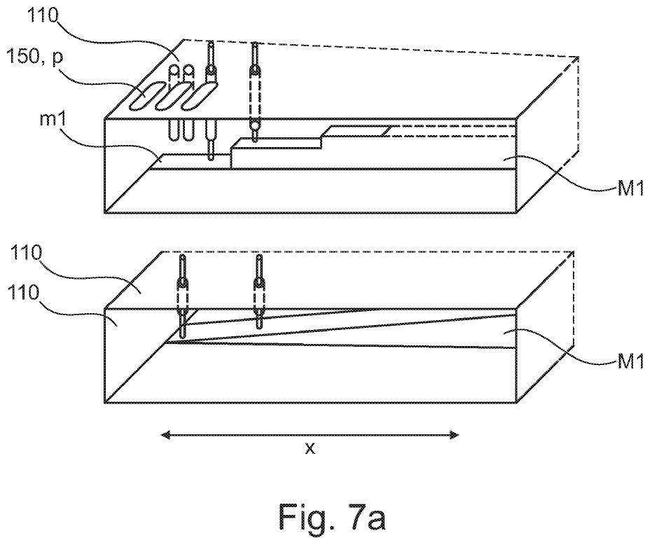

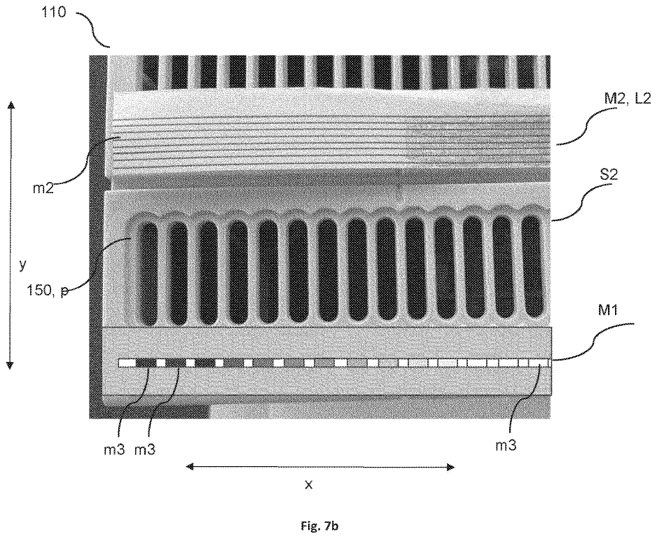

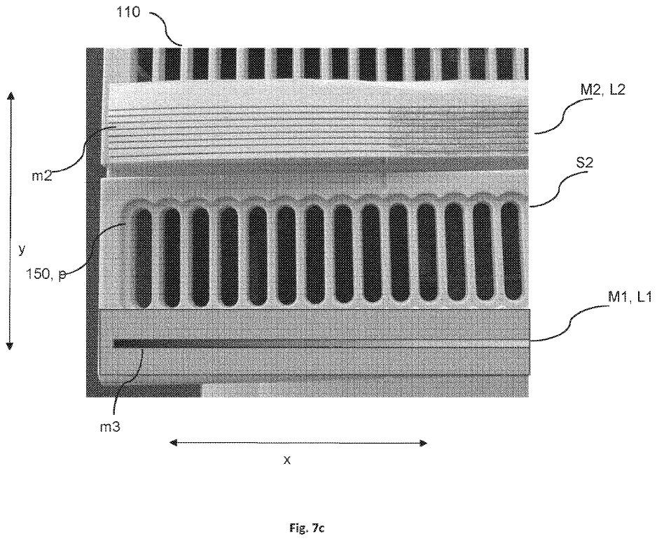

The mark m3 may comprise at least one groove m3, extending in the first direction x. FIG. 7a, b, c illustrate such a cover with one groove m3 in the first direction x in the surface 110 of the touch protection cover 100.

FIG. 7a is a cut view from a side along the first direction x, FIG. 7b and FIG. 7c illustrate views onto the surface 110. The depth of the groove m3 may change as a function of the distance from an edge of the protection cover 100 in the direction x, that is, the depth is linked with the positions position p. Thus, the position p is coded as the depth of the groove m3 which is related to a position p of a slit 150.

The depth may be varied stepwise in form of stairs, each step corresponding to the position p of another slit 150 as illustrated in FIG. 7a (above) and FIG. 7b, or continuously in form of a wedge, as illustrated in FIG. 7a (bottom) and FIG. 7c.

In yet further variants, the information m1, m2 may be coded as magnetic patterns. Such patterns are less susceptible to dust than e.g., graphical patterns. So, they may be good choice in particularly dusty environments.

It is to be noted that several variants may be combined in one touch protection cover 100. That is, information can be coded according to the different variants either redundantly, or parts of information according to one variant and other parts according to other variant(s).

Each of the first marks m1 and/or second marks m2 may be aligned with another slit 150. In this way, the first marks m1 are associated with the positions p of the slits 150 on the touch protection cover 100.

The marks m1, m2 are adapted to be detected by the electrical installation devices 200 which are to be attached on the touch protection cover 100 at predetermined positions p along the first direction x. Hereto, the electrical installation devices 200 are equipped with suitable sensing means 250. Such sensing means 250 may be optical CCD sensors.

As an example, a typical touch protection cover 100 may have 244 slits 150 along a line L1, L2, L3, each slit 150 having a width of 4.5 mm along L1, L2, L3. That is, 150 different positions p for electrical installation devices along the first direction x may be given per each touch protection cover 100. A typical mark m1, m2 for this configuration may then have the dimension of 1 mm×4.5 mm, and the spatial resolution of the sensing means 250 should be higher than 1 mm×4.5 mm. Then, an 8 bit number (=256 values) may be sufficient for coding all the 244 positions p.

Low-cost VGA sensors (644×488 pixels) image sensors should be sufficient.

Embosses, elevations or blind holes, or through holes may be detected by mechanical switches/detectors as well as by optical means.

Such detectors may be sticks coupled with potentiometers or the like.

Optical means may also comprise optical interferometers.

In general, the electrical installation device 200 covers more than one slit 150 in in the first direction x, that is, the electrical installation device 200 is much broader than one slit 150. In order to get the full span of positions p or slits 150 the particular electrical installation device 200 covers in the first direction x, the sensing means 250 may be adapted to sense the leftmost and the rightmost positions p of the electrical installation device when attached on the cover 100. Hereto, two sensors may be provided, one placed at the left edge, the other placed at the right edge of the particular electrical installation device 200.

As an alternative, only one sensor is provided and the sensing means reports not only the position p but also the width of the electrical installation device 200. Hereto, data descriptive of the width in the first direction x of the electrical installation device must be available to the sensing means 250. This data may be stored in the electrical installation device 200.

If the busbar system comprises low voltage busbar(s) 20D dedicated to communication purposes, the sensing means 250 may be integrated in a communication adapter associated with the respective electrical installation device 200 sitting on and connected with the communication busbar 20D.

Then, it may acquire and transmit its position p directly via the communication busbar(s) 20D to a receiver unit 300 connected with the communication busbar(s) 20D.

FIG. 8a illustrates such a configuration, where the busbar system additionally comprises a communication busbar system 20D. The communication busbar system 20D comprises a stack of several low voltage busbars. The stack is placed, in this configuration, above the uppermost high voltage busbar 20. The structure M1 may be arranged on top of a cover 100D covering the stack.

The sensing means 250, for all variants of the marks, may be adapted to just acquire the one mark m1 corresponding to the one slit 150 at the position p (and m2 if present) where the electrical installation device 200 is actually positioned in the switching cabinet on the protection cover 100.

If the sensing means 250 is adapted to acquire more than one mark m1, further processing capabilities may be necessary to determine the correct position p.

If the first structure M1 comprises a groove m3, the sensing means 250 may comprise a mechanical distance sensor which delivers a signal representative of the depth of the groove m3 at the particular position p where the electrical installation device is placed. S

As can be seen in FIG. 8a and already mentioned above, the sensing means 250 may be arranged on the outside of the housing of the electrical installation device 200, e.g., separately on top or bottom of the electrical installation device 200. Then, it may be sufficient to adapt the housing of the electrical installation device 200 to receive the sensing means 250.

This configuration for the electrical installation device 200 may also be advantageous for example if the busbar system additionally comprises the communication busbar system 20D which runs in the first direction x too. The acquired information or position p may be transmitted over the communication busbar 20D to a third party, as mentioned above.

The touch protection cover assembly may comprise additionally to the touch protection cover 100 covering the high voltage busbars 20 a cover 100D covering the communication busbar system 20D. Then, the first and/or second marks m1, m2 may be applied adjacent to the communication busbar system 20D. That is, the first and/or second marks may be applied on the cover 100D.

On the other hand, in a variant illustrated in FIG. 8b, the sensing means 250 may be fully integrated within the electrical installation device 200.

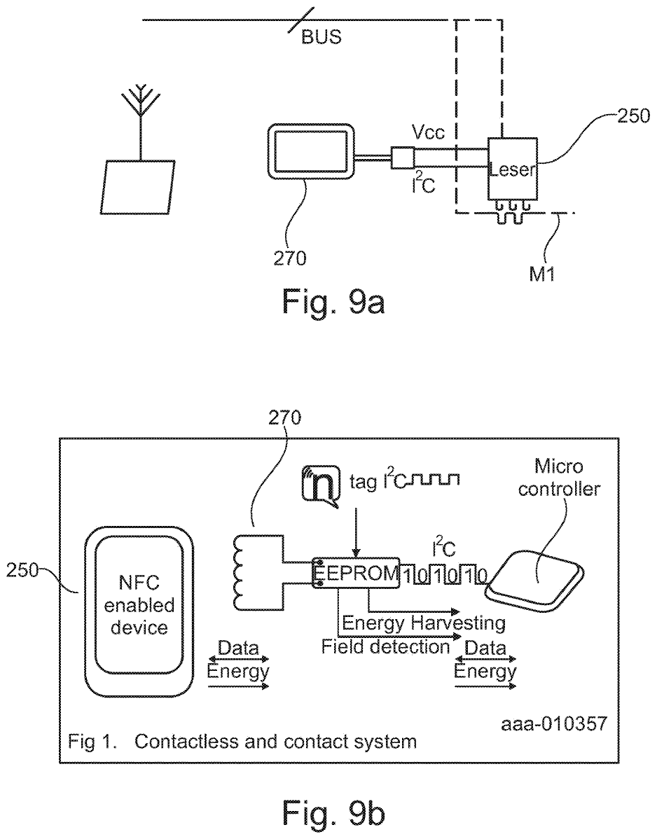

FIG. 9a, b illustrate an exemplary position sensing means 250 which can be used with the first structure M1 comprising the marks m1, m2, m3. The sensing means 250 such as a reader or CCD sensor may be connected with and powered by an NFC tag 260 which in turn harvests the energy via its antenna 270 needed via its antenna from an NFC enabled communication device. The communication of the detection device and the NFC tag 260 may be done under the serial I2C protocol known as such in the art.

For all variants of marks, further processing capabilities may be present for transforming determined positions p into metric dimensions if they are not directly contained in the marks.

### LIST OF REFERENCE NUMERALS

20 busbar
20D communication busbar
25 slit of busbar
100 touch protection cover
110 front surface
120 side surface
130 side surface
140 back cover
150 slit
200 electrical installation device
250 sensing means
260 NFC tag
270 antenna
300 receiver unit
D1 further line
L1 first line
L2 second line
m1; m1a, m1b first information, first mark
M1; M1a, M1b first structure
M2; M2a, M2b second structure
m2; m2a, m2b individual information, second mark
m3 groove
p position
S1, S2, S3 line of slits
x first direction
y second direction

What is claimed is:

1. A touch protection cover assembly for covering at least one current busbar, comprising:
at least one touch protection cover with a predetermined number of slits, the slits being arranged at predetermined positions on the at least one touch protection cover along a first direction, each slit extending in a second direction which is perpendicular to the first direction,
the slits allowing at least one electrical installation device to be mounted onto the at least one busbar when the at least one touch protection cover is attached to the at least one current busbar;
the touch protection cover assembly further comprising:
a structure being arranged along a first line on the at least one touch protection cover, which first line is parallel to the first direction,
the structure comprising information which is descriptive for the at least one touch protection cover,
the information being adapted to be sensed by the at least one electrical installation device, when mounted onto the at least one current busbar.

2. The touch protection cover assembly of claim 1, wherein the structure comprises marks, and the information is comprised in the marks.

3. The touch protection cover assembly of claim 2, wherein the structure comprises a first structure and the marks comprise first marks, the first structure comprising the first marks having information which is representative of the predetermined positions on the at least one touch protection cover.

4. The touch protection cover assembly of claim 3, wherein each mark corresponds to another slit.

5. The touch protection cover assembly of claim 4, wherein each slit is aligned, in a predetermined second direction, with another one of the first marks, the second direction being preferably orthogonal to the first direction.

6. The touch protection cover assembly of claim 1, wherein the structure comprises a second structure and the marks comprise second marks), the second structure comprising the second marks having information which comprises individual information relating to the at least one touch protection cover.

7. The touch protection cover assembly of claim 1, wherein the marks comprise at least one elevation on a surface of the at least one touch protection cover and the information is at least one height of the at least one elevation.

8. The touch protection cover assembly of claim 1, wherein each mark comprises at least one recess in a surface of the at least one touch protection cover and the information is at least one depth of the at least one recess.

9. The touch protection cover assembly of claim 1, wherein the marks comprise a number of through holes in a surface of the at least one touch protection cover and the information is the respective number or positions of the through holes.

10. The touch protection cover assembly of claim 1, wherein the marks are arranged on at least one surface of the at least one touch protection cover, the at least one surface extending in the first direction, the at least one surface being at least one of:
a front surface; and
a side surface.

11. The touch protection cover assembly of claim 1, wherein the information is coded as graphical patterns, in particular comprising at least one of:
QR code;
bar code;
triangular area;
alphanumeric figures
binary patterns.

12. The touch protection cover assembly of claim 1, wherein the information is coded as magnetic patterns.

13. The touch protection cover assembly of claim 1, wherein the structure comprises a groove with variable depth, and the information being the depth of the at least one groove.

14. The touch protection cover assembly of claim 13, wherein the depth is varied continuously in form of a wedge.

15. The touch protection cover assembly of claim 13, wherein depth is varied stepwise in form of stairs, each step corresponding to another position.

16. The touch protection cover assembly of claim 3, wherein the first marks are coded in a Gray code manner.

17. The touch protection cover assembly of claim 6, wherein the second marks are comprised in a separate layer applicable on the touch protection cover.

18. The touch protection cover assembly of claim 1, wherein the individual information comprises a position of the at least one touch protection cover with respect to the least one current busbar, when attached to the at least one busbar.

19. The touch protection cover assembly of claim 1, wherein the second marks are arranged along a second line in the first direction on the at least one touch protection cover.

20. The touch protection cover assembly of claim 1, wherein the second line is adjacent to the first line.

21. An electrical installation device for attaching to at least one busbar at predetermined positions on at least one touch protection cover assembly according to claim 1, the touch protection cover assembly covering the at least one busbar, the electrical installation device further comprising:
means for sensing the information of the structure.

22. The electrical installation device of claim 21, further comprising:
means for transmitting the acquired information to a third party.

23. The electrical installation device of claim 22, wherein the information sensing means comprise:
optoelectronic detection means;
mechanical detection means;
magnetic detection means; or
ultrasonic detection means.
